(19) United States
(12) Patent Application Publication
(10) Pub. No.: US 2010/0038891 A1
(43) Pub. Date: Feb. 18, 2010

(54) INSTRUMENT PANEL FOR MOTOR VEHICLE

(76) Inventors: Bryan Welch, Davison, MI (US); Padathukatil Jayan, Chennai (IN); David C. Pudduck, White Lake, MI (US); Jeff Bruland, Brighton, MI (US)

Correspondence Address: MACMILLAN, SOBANSKI & TODD, LLC, ONE MARITIME PLAZA-FIFTH FLOOR, 720 WATER STREET, TOLEDO, OH, 43604, US

(21) Appl. No.: 12/189,832

(22) Filed: Aug. 12, 2008

(51) Int. Cl. B60R 21/205; B62D 25/14

(52) U.S. Cl. 280/732; 296/70

(57) ABSTRACT

An instrument panel for a motor vehicle is disclosed herein. The instrument panel includes a body extending along a lateral axis between an outboard side and an inboard side. The body has an outwardly-facing surface for display in a passenger compartment of a motor vehicle and an inwardly-facing surface opposite the outwardly-facing surface. The instrument panel also includes a plurality of mounting structures associated with the body. The instrument panel also includes a score pattern formed in the inwardly-facing surface including first and second score lines extending substantially parallel to one another. The score pattern also includes a third score line extending between the first and second score lines. The third score line being oblique to at least one of the first and second score lines.

### BACKGROUND OF THE INVENTION

This invention relates in general to an instrumental panel for concealing an inflatable restraint in a motor vehicle.

When the inflatable restraint is activated, the expanding restraint can burst through the instrument panel, forming doors in the instrument panel. The doors thus-formed could interact with a passenger of the vehicle.

The Federal Motor Vehicle Safety Standard & Regulations specifies performance requirements for motor vehicles generally and the performance of restraints systems in particular. Standard No. 208 (49 CFR 571.208) addresses the protection of vehicle occupants in crashes specifies vehicle crashworthiness requirements. These requirements are defined in terms of forces and accelerations applied to anthropomorphic dummies in test crashes. Sub-sections 14, 23 and 24 of Standard No. 208 detail advanced air bag requirements for passenger cars and trucks. More particularly, these sub-sections relate to the performance of an inflatable restraint when a child is in the front seat. The standards contemplate the situation where a six-year-old child is out-of-position. Subsection 24.4.3 details a test for such a condition, in particular when the six-year-old child's head or torso is contacting the instrument panel. Under the test, the dummy's head will be positioned in proximity to the portion of the instrument panel that will burst open when the inflatable restraint activates.

### SUMMARY OF THE INVENTION

In summary, the invention is an instrument panel for a motor vehicle. The instrument panel includes a body extending along a lateral axis between an outboard side and an inboard side. The body has an outwardly-facing surface for display in a passenger compartment of a motor vehicle and an inwardly-facing surface opposite the outwardly-facing surface. The instrument panel also includes a plurality of mounting structures associated with the body. The instrument panel also includes a score pattern formed in the inwardly-facing surface including first and second score lines extending substantially parallel to one another. The score pattern also includes a third score line extending between the first and second score lines. The third score line being oblique to at least one of the first and second score lines.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a top view of an instrument panel according to the exemplary embodiment of the invention;

FIG. 2 is a side view of a combination including the exemplary instrument panel; and

FIG. 3 is an exploded view of an air bag assembly according to the exemplary embodiment of the invention.

### DETAILED DESCRIPTION OF THE PREFERRED EMBODIMENT

Referring now to the drawings, an instrument panel 10 for a motor vehicle according to the exemplary embodiment of the invention. The instrument panel 10 includes a body 12 extending along a lateral axis 14 between an outboard side 16 and an inboard side 18. The body 12 includes an outwardly-facing surface 20 for display in a passenger compartment 22 of the motor vehicle and an inwardly-facing surface 24 opposite the outwardly-facing surface 20.

The instrument panel 10 can also include a plurality of mounting structures 26 associated with the body 12, such as by being integrally formed with or operably connected to the body 12. The mounting structures 26 can further attaching the body 12 to the motor vehicle and can be any desired configuration. By way of example and not limitation, the mounting structures 26 can take the form of apertures, bosses, “Christmas trees” shapes, detents, tangs, or any other structure. The exemplary mounting structures 26 are substantially planar projections 28 from the body 12 with apertures 30 defined in the planar projections 28.

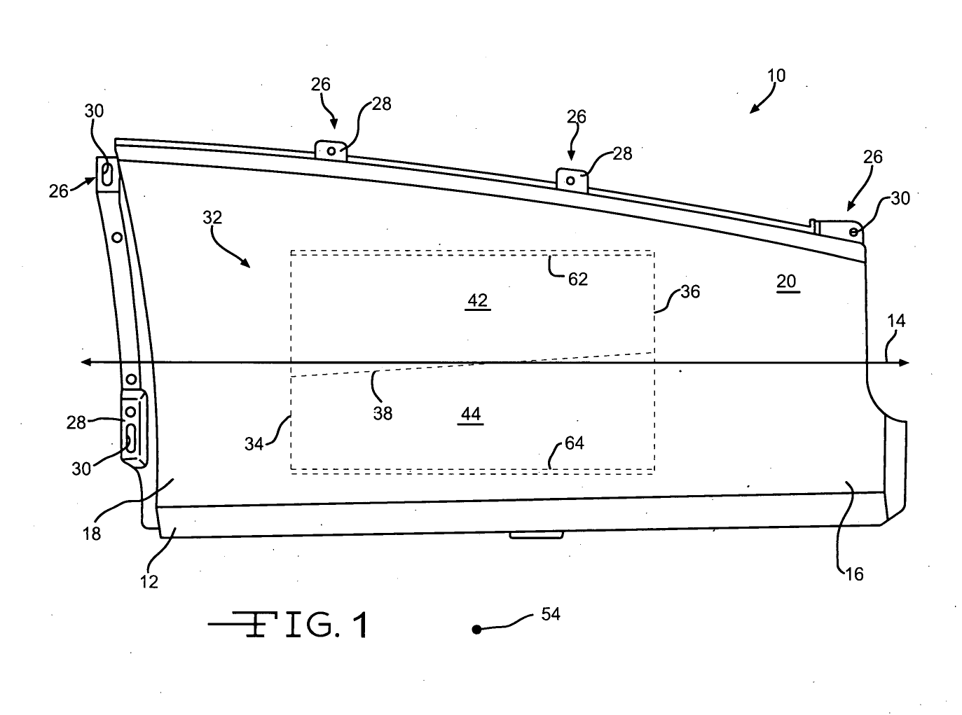

The instrument panel 10 also includes a score pattern 32 formed in the inwardly-facing surface 24. The score pattern 32 is visible in FIG. 1 and is shown in phantom since FIG. 1 is a top view of the instrument panel 10. The score pattern 32 includes first and second score lines 34, 36 extending substantially parallel to one another. The first and second score lines 34, 36 can be non-parallel in alternative embodiments of the invention. The score pattern 32 also includes a third score line 38 extending between the first and second score lines 34, 36. In the invention, the third score line 38 is oblique to at least one of the first and second score lines 34, 36. In the exemplary embodiment of the invention, the third score line 38 is oblique to both of the first and second score lines 34, 36. The exemplary third score line 38 is straight and oblique to both of the first and second score lines 34, 36.

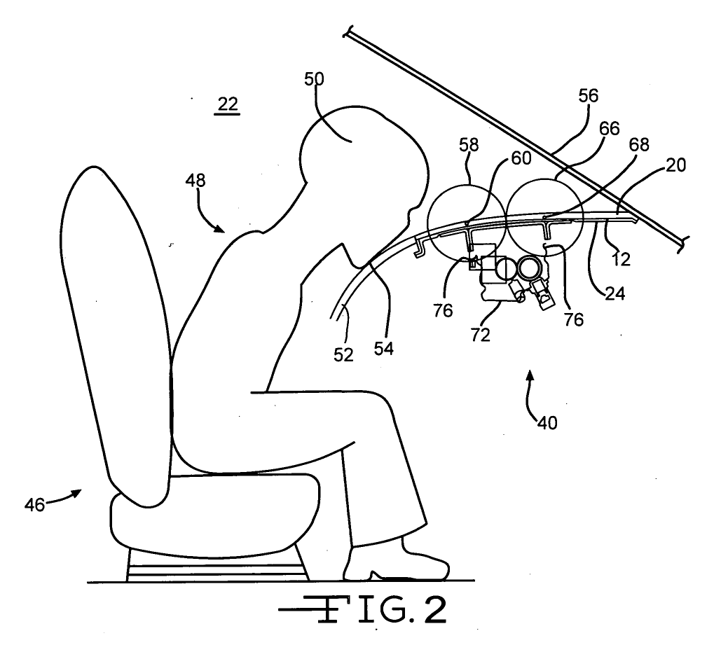

FIG. 2 is a view from the outboard perspective of the motor vehicle, looking inward. FIG. 2 shows an inflatable restraint 40 disposed adjacent the inwardly-facing surface 24. The inflatable restraint 40 is disposed beneath the body 12 proximate to the score pattern 32 shown in FIG. 1. The inflatable restraint 40 is operable to burst through the body 12 upon engagement and thereby form first and second doors 42, 44 in the body 12. The first and second doors 42, 44 each being irregular polygons with three exposed sides and one side being a hinging axis portion with the body 12. A pair of hinging axis portions 62, 64 are shown in double dash line in FIG. 1. In the exemplary embodiment of the invention, the first and second doors 42, 44 are similarly sized trapezoids.

FIG. 2 also shows a vehicle seat 46 disposed for adjustable movement relative to the instrument panel 10. An anthropomorphic dummy 48 corresponding to a six-year-old child is positioned on the vehicle seat 46. The vehicle seat 46 and anthropomorphic dummy 48 are shown in FIG. 2 in positions corresponding to testing under Subsection 24.4.3 of Standard No. 208 (49 CFR 571.208). The positions of the vehicle seat 46 and anthropomorphic dummy 48 shown in FIG. 2 correspond to the situation where a six-year-old child is out-of-position. A head 50 of the anthropomorphic dummy 48 is contacting the instrumental panel generally. It is noted that in the exemplary embodiment of the invention the head 50 of the anthropomorphic dummy 48 is contacting a secondary instrument panel 52. The secondary instrument panel 52 cooperates with the instrument panel 10 in the exemplary embodiment of the invention to form at least part of the front of the passenger compartment 22 which faces the occupants in the front row of the vehicle. In alternative embodiments of the invention, the instrument panel 10 and secondary instrument panel 52 could be integral. The anthropomorphic dummy 48 is contacting a secondary instrument panel 52 at a point 54. The point 54 is also shown in FIG. 1 for reference.

Under testing, the head 50 of the anthropomorphic dummy 48 will be positioned in proximity to the portion of the instrument panel 10 that will burst open when an inflatable restraint 40 activates, the first and second doors 42, 44. Thus it may seem desirable to position the score pattern 32 close to a windshield 56 of the vehicle to prevent contact between the second door 44 and the head 50. In other words, it may seem desirable to move the score pattern 32 upward on the body 12 relative to the perspective of FIG. 1. However, it may also be desirable to prevent contact between the first door 42 and the windshield 56. To serve this goal, it may seem desirable to move the score pattern 32 downward on the body 12 relative to the perspective of FIG. 1.

The exemplary embodiment of the invention accomplishes both goals concurrently. The third score line 38 is oriented such that neither of the first and second doors 42, 44 contacts the head 50 of an out-of-position six-year-old anthropomorphic dummy 48 during testing. Furthermore, the windshield 56 and the third score line 38 are positioned relative to one another such that neither of the first and second doors 42, 44 contact the windshield 56 when the inflatable restraint 40 engages. The third score line 38 is furthest from the vehicle seat 46 at an outboard end. FIG. 2 shows a first circle 58 centered on a first point 60. The portion of the first circle 58 above the surface 20 corresponds to the path of movement of the distal end of the second door 44. The distal end of the second door 44 is defined by the third score line 38. The hinging axis portion 64 corresponds to the point 60. The first circle 58 is taken in a plane between the first and second score lines 34, 36 at which the second door 44 will be closest to the head 50 of an out-of-position six-year-old anthropomorphic dummy 48. As shown in FIG. 2, the second door 44 will not contact the head 50 of an out-of-position six-year-old anthropomorphic dummy 48.

FIG. 2 also shows a second circle 66 centered on a second point 68. The portion of the second circle 66 above the surface 20 corresponds to the path of movement of the distal end of the first door 42. The distal end of the first door 42 is defined by the third score line 38. The second point 68 corresponds to the hinging axis portion 62. The second circle is taken in a plane substantially containing the second score line 36 since it will be in this plane that the distal end of the first door 42 will be closest to the windshield 56 in the exemplary embodiment of the invention. As shown in FIG. 2, the first door 42 will not contact the windshield 56.

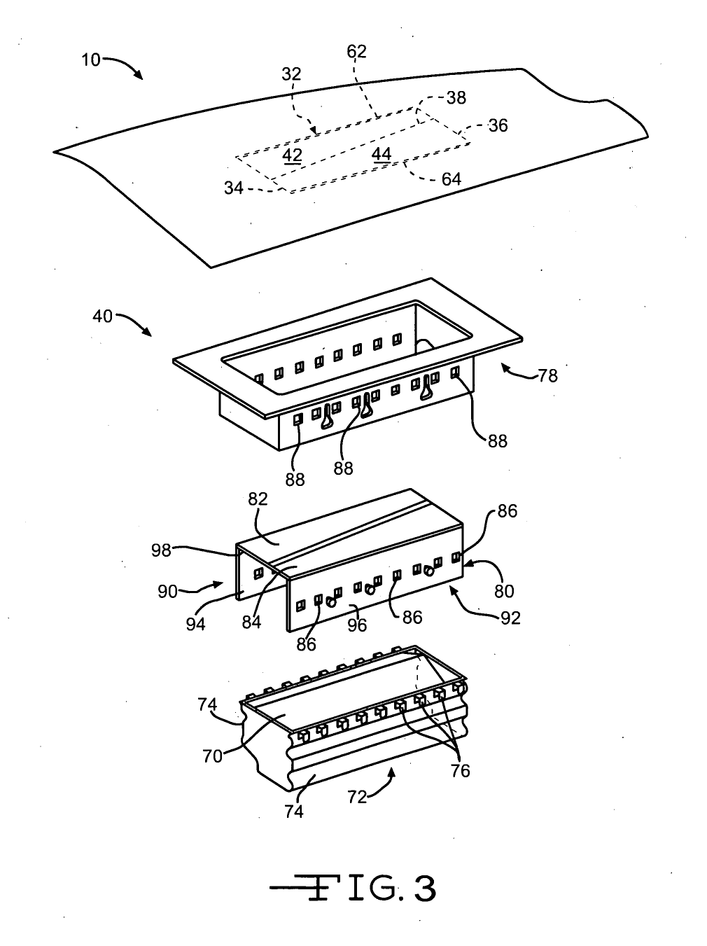

FIG. 3 shows an exploded view of the inflatable restraint 40 in accordance with an embodiment of the invention. The instrument panel 10 forms a cover over the inflatable restraint 40. As should be readily understood, the inflatable restraint 40 can be any type of system having an inflatable airbag 70 for protecting a passenger seated in the passenger compartment. The airbag 70 can be inflated by an inflator (not shown) in response to a signal from a controller (now shown) indicating an alert indicative of a collision from a sensing device (not shown), as is well known in the art.

The instrument panel 10 can include a single layer of plastic, such as thermosplastic olefin (TPO), thermoplastic elastomer (TPE), thermosplastic urethane (TPU), polycarbonate (PC), polypropylene (PP), SMA, acrylonitrile-butadiene-styrene (ABS), or PC/ABS. The instrument panel 10 could be a laminate of multiple layers, including by example and not limitation a layer of foam.

Referring to FIG. 1, the instrument panel 10 can include the score pattern 32 that, at least in the illustrated embodiment, operates to divide the cover into two door halves 42, 44. The illustrated score pattern 32 comprises a center third score line 38 and side score lines 34, 36. The score line 38 is oblique relative to both of the score lines 34, 36. Two hinging axis portions are defined at 62 and 64 (again in double-dash).

The inflatable restraint 40 illustrated in FIG. 3 includes a reaction canister 72 which houses the airbag 70 (in an undeployed state). The reaction canister 72 also houses the inflator (not shown) which provide inflation fluid for inflating the airbag 70 when necessary. The reaction canister 72 illustrated in FIG. 1 is generally rectangular and includes opposed sidewalls 74 with each sidewall having a plurality of hooks 76 extending therefrom.

The inflatable restraint 40 further include a door chute assembly 78 and a cooperating door panel assembly 80. The assemblies 78, 80 can both be made of the same or different suitable plastic materials. Examples of suitable plastic materials include, but are not necessarily limited to, thermoplastic elastomer (TPE), thermoplastic polyurethane (TPU), thermoplastic olethin (TPO), polyvinyl chloride (PVC), and polyofefins, such as PP.

The assemblies 78, 80 can be secured to the instrument panel 10 in any suitable manner. For instance, the chute assembly 78 and the door panel assembly 80 can be secured to the instrument panel 10 by vibration welding, bolts, screws, rivets, adhesive and sonic welding. The chute assembly 78 helps to guide deployment of the airbag 70 and reinforce the score pattern 32. The chute assembly 78 also helps inhibit the linear movement of door panels 82, 84 defined in the assembly 80. The door panel assembly 80 helps to open door halves 42, 44. The door panels 82, 84 remain attached to the chute assembly 78 during deployment, and reinforce the score pattern 32.

The individual hooks 76 can be received in individual windows 86 of the assembly 80 and individual windows 88 of the assembly 78. Thus, the reaction canister 72 can be mounted to the instrument panel 10. The assembly 80 is formed from first and second members 90 and 92. Each of the first and second members 90 and 92 can be shaped to include the respective door panels 82, 84 and also include respective side panels 94 and 96. The door panel 82 and the side panel 94 can be integrally formed and be disposed at an angle of ninety degrees relative to one another prior to inflation of the air bag. Likewise, the door panel 84 and the side panel 96 can be integrally formed and be disposed at an angle of ninety degrees relative to one another. The junction of the door panel 82 and the side panel 94 is positioned adjacent to one of the hinging axis portions 62, 64 of the instrument panel 10 and the junction of the door panel 84 and the side panel 96 is positioned adjacent to the other one of the hinging axis portions 62, 64. The door panels 82 and 84 can abut one another along a seam 98. When the air bag inflates, the air bag passes through the seam 98 and the door panels 82, 84 move to an angle of one hundred and eighty degrees relative to the respective side panels 94, 96.

The structure shown in FIG. 3 is similar to the structure shown in FIG. 1 of U.S. Pat. No. 7,234,724. U.S. Pat. No. 7,234,724 is therefore incorporated by reference for all disclosure relating to the inflatable restraint 40.

The principle and mode of operation of this invention have been explained and illustrated in its preferred embodiment. However, it must be understood that this invention may be practiced otherwise than as specifically explained and illustrated without departing from its spirit or scope.

What is claimed is:

1. An instrument panel for a motor vehicle comprising:
a body extending along a lateral axis between an outboard side and an inboard side and having an outwardly-facing surface for display in a passenger compartment of a motor vehicle and an inwardly-facing surface opposite said outwardly-facing surface;
a plurality of mounting structures associated with said body; and
a score pattern formed in said inwardly-facing surface including first and second score lines extending substantially parallel to one another and a third score line extending between said first and second score lines, wherein said third score line being oblique to at least one of said first and second score lines.

2. The instrument panel of claim 1 wherein said third score line is straight and oblique to both of said first and second score lines.

3. A combination of the instrument panel of claim 1 and an inflatable restraint disposed adjacent said inwardly-facing surface at said score pattern and operable to burst through said body upon engagement and thereby form first and second doors in said body, said first and second doors each being irregular polygons with three exposed sides and one side being a hinging axis portion with said body.

4. The combination of claim 3 wherein said first and second doors are similarly sized trapezoids.

5. The combination of claim 3 further comprising:
a vehicle seat disposed for adjustable movement relative to said instrument panel, said vehicle seat and said third score line being positionable relative to one another such that neither of said first and second doors contact the head of an out-of-position six-year-old anthropomorphic dummy during testing.

6. The combination of claim 5 further comprising:
a windshield disposed in fixedly-spaced relation to said instrument panel, said windshield and said third score line being positionable relative to one another such that neither of said first and second doors contact said windshield when said inflatable restraint engages.

7. The combination of claim 6 wherein said outwardly-facing surface is substantially horizontal.

8. The combination of claim 6 wherein said third score line is furthest from said vehicle seat at an outboard end.
